(19) United States
(12) Patent Application Publication
(10) Pub. No.: US 2011/0211870 A1
(43) Pub. Date: Sep. 1, 2011

(54) DEVELOPING DEVICE AND IMAGE FORMING APPARATUS

(76) Inventor: Katsumi ADACHI, Osaka (JP)

(21) Appl. No.: 13/032,659

(22) Filed: Feb. 23, 2011

(30) Foreign Application Priority Data
Mar. 1, 2010 (JP) 2010-044575

(51) Int. Cl. G03G 15/08

(52) U.S. Cl. 399/284

(57) ABSTRACT

A developing device is provided. A developing device bears a developer stored in a developer tank on a developing roller and conveys the developer to a photoreceptor drum to develop an electrostatic latent image. A doctor blade is provided to come into pressure-contact with the developing roller, and regulates layer thickness of the developer borne on the developing roller. The doctor blade has an elastic rubber section and a support section. The support section has a fixation section that is formed into a plate shape in parallel to the axis of the developing roller and is fixed to the developer tank, and an insertion section that continues from the fixation section and is inserted into the elastic rubber section. The insertion section has an proximity curved section that is curved in a direction in proximity to the developing roller.

### CROSS-REFERENCE TO RELATED APPLICATION

This application claims priority to Japanese Patent Application No. 2010-044575, which was filed on Mar. 1, 2010, the contents of which are incorporated herein by reference in its entirety.

### BACKGROUND OF THE INVENTION

1. Field of the Invention

The present invention relates to a developing device for developing an electrostatic latent image formed on an image bearing member with use of a toner, and an image forming apparatus provided with the developing device.

2. Description of the Related Art

An electrophotographic image forming apparatus supplies a toner constituting a developer from a developing device to an electrostatic latent image formed on the surface of an image bearing member for development, thereby forming a toner image which is a visualized image, and further transfers the toner image to recoding paper or the like serving as a transfer medium and fixes the toner image transferred to the recording paper to form a firm recording image.

In recent years, due to popularization of color inkjet image forming apparatuses, miniaturization and cost reduction are also required for electrophotographic image forming apparatuses.

Under such circumstances, for a developing device provided in an electrophotographic image forming apparatus, a non-magnetic one-component developing type which is of a simple configuration and is capable of size reduction is useful and development of improvement technology is still progressing. The non-magnetic one-component developing type developing device includes a contact development type in which a developing roller serving as a developer bearing member makes contact with an image bearing member for development and a non-contact development type in which a developer is supplied for development from a developing roller which is disposed at a predetermined distance from an image bearing member. In both the types, the configuration of the developing devices themselves is similar with a feature of being compact, but there is a case where materials of the developing rollers are different from each other.

In the contact development type developing device, the developing roller is constituted by a conductive elastic member such as rubber, to obtain uniform contact in a development area. In particular, when a rigid body such as a photoreceptor drum is used as the image bearing member, it is useful that the developing roller is constituted by an elastic member in order to prevent scratch caused by failure of the contact state. In addition, in the case of the developing roller formed of a rubber material, as a layer thickness regulating member for forming a developer layer on the surface of the developing roller, a rubber blade, a roller-type blade formed of a metal shaft, a blade of a single metal plate or the like is used. Among them, the blade formed of a single metal plate is able to be provided at a low cost and is therefore widely used.

In the non-contact development type developing device, since the developing roller needs to keep precisely the distance from the image bearing member, a roller and a sleeve formed of a rigid body such as metal are often used. This is because they are effective for improving polishing precision of the surface and for suppressing decentering of a driving axis and the surface, compared to a rubber roller. Further, this is also because they have no causes, because of being non-contact, for concerns about a scratch on the image bearing member caused by contact. Although the layer thickness regulating member for forming the developer layer on the surface of the developing roller is able to be constituted similarly to the case of the contact development type developing device described above, a rubber blade is often used in order to stabilize the contact in a layer thickness regulating section which makes contact with the surface of the developing roller to regulate layer thickness of the developer layer and to prevent a scratch on the developing roller. Examples of the rubber blade include one in which a layer thickness regulating section and a support section for supporting the layer thickness regulating section are all constituted by a single rubber material and one in which the layer thickness regulating section is constituted by a rubber material and the support section is constituted by an elastic metal plate.

Examples of a contacting method for bringing the layer thickness regulating section of the layer thickness regulating member into contact with the surface of the developing roller, include an edge contacting method in which an outer edge of the layer thickness regulating section is brought into contact with the surface of the developing roller, and a surface contacting method in which a center part of a bottom face of the layer thickness regulating section is brought into contact with the surface of the developing roller.

In the edge contacting method, the layer thickness regulating section makes line contact with the surface of the developing roller so that a distribution curve of the contacting pressure against the developing roller becomes sharp, thus making it possible to reduce the thickness of the developer layer formed on the surface of the developing roller (see Japanese Unexamined Patent Publication JP-A 2001-13781). However, since the edge contacting method is sensitive to the shape of the outer edge of the layer thickness regulating section which is brought into contact with the surface of the developing roller and the precision of the contacting point, it is impossible to form the thin layer of the developer uniformly on the surface of the developing roller.

In the surface contacting method, the effect of the surface precision of the contacting face of the layer thickness regulating section which is brought into contact with the surface of the developing roller and the precision of the contacting point is relatively mild, so that it is possible to form the developer layer uniformly on the surface of the developing roller. However, in the surface contacting method, the contacting pressure against the developing roller in the area where the layer thickness regulating section makes contact with the surface of the developing roller is high in the vicinity of a center line parallel to an axis of the developing roller and becomes lower as going outward from the center line, resulting that the pressure distribution curve becomes broad. In this manner, the broad distribution curve of the contacting pressure against the developing roller arises from a difference of the amount of elastic deformation of the layer thickness regulating section, which is caused when the plate-like layer thickness regulating section whose thickness is uniform is brought into contact with the cylindrical developing roller.

In recent years, with growing demands for image formation with high image quality, downsizing of particle size of a toner serving as a developer is progressed and the thickness of a developer layer formed on a surface of a developing roller needs to be reduced accordingly. In the surface contacting method, the distribution curve of the contacting pressure against the developing roller becomes broad, so that it is difficult to reduce the thickness of the developer layer formed on the surface of the developing roller. For example, by increasing the contacting pressure of the layer thickness regulating section against the developing roller, it is possible to reduce the thickness of the developer layer formed on the surface of the developing roller, but in such a case, the area where the layer thickness regulating section makes contact with the surface of the developing roller increases, and further the pressure becomes a high state over the whole area. Thus, excess stress is placed on the developer layer formed on the surface of the developing roller and the developer constituting the developer layer is deteriorated, resulting in a problem of causing image defects. In addition, when the pressure is high over the whole area of the surface of the developing roller, a housing of the developing device supporting the developing roller is easily deformed, and there are concerns that cost will be high in order to take a measure to improve the strength for avoiding the occurrence of deformation and the like.

In order to solve such problems, JP-A 2000-112230 discloses that a layer thickness regulating section formed of an elastic rubber material has a convex shape such as a semicircular shape. In such a convex layer thickness regulating section, a convex part of a bottom face of the layer thickness regulating section is brought into contact with the surface of a developing roller to form a developer layer, so that a distribution curve of the contacting pressure against the developing roller becomes sharp. Accordingly, it is possible to increase the contacting pressure at a narrow area where the layer thickness regulating section makes contact with the surface of the developing roller, thus making it possible to reduce the thickness of the developer layer formed on the surface of the developing roller while preventing occurrence of deterioration of the developer and the like.

However, since it is difficult to die-mold the layer thickness regulating section formed of the elastic rubber material into the convex shape with high surface precision, it is impossible to form the thin layer of the developer uniformly on the surface of the developing roller, so that it is impossible to develop an electrostatic latent image on a photoreceptor drum with high image quality. Further, when the shape of the layer thickness regulating section is changed to change the contacting pressure and the width of the contacting area against the surface of the developing roller, there is also a problem of causing the labor and cost increase for changing the die for molding in order to keep the high surface precision of the layer thickness regulating section.

### SUMMARY OF THE INVENTION

An object of the invention is to provide a developing device capable of forming a uniform thin layer of a developer on a developer bearing member and developing an electrostatic latent image on an image bearing member with high image quality, and an image forming apparatus provided with the developing device.

The invention provides a developing device for developing an electrostatic latent image borne on an image bearing member provided to be rotatable, with use of a developer, comprising:
a developer tank that stores the developer;
a developer bearing member that is provided to be rotatable in the developer tank and is arranged facing the image bearing member so that an axis thereof is parallel to an axis of the image bearing member, and bears and conveys the developer stored in the developer tank to the image bearing member; and
a layer thickness regulating member that is provided to come into pressure-contact with the developer bearing member, and regulates layer thickness of the developer borne on the developer bearing member,
the layer thickness regulating member having
an elastic rubber section that is formed into a plate shape and is provided so as to make surface contact with the developer bearing member over between both ends thereof in a direction of axis of the developer bearing member, and
a support section that is elastic, and supports the elastic rubber section, and
the support section having
a fixation section that is formed into a plate shape in parallel to the axis of the developer bearing member and has one end fixed to the developer tank, and
an insertion section that continues from the other end of the fixation section and is inserted into the elastic rubber section, the insertion section having a proximity curved section that is curved in a direction in proximity to the developer bearing member.

According to the invention, a developing device bears a developer stored in a developer tank on a developer bearing member and conveys the developer to an image bearing member to develop an electrostatic latent image. A layer thickness regulating member is provided to come into pressure-contact with the developer bearing member, and regulates layer thickness of the developer borne on the developer bearing member that is driven to rotate. The layer thickness regulating member has an elastic rubber section that is formed into a plate shape and is provided so as to make surface contact with the developer bearing member over between both ends in a direction of axis of the developer bearing member, and a support section for supporting the elastic rubber section. The support section that supports the elastic rubber section has a fixation section that is formed into a plate shape in parallel to the axis of the developer bearing member and fixed to the developer tank, and an insertion section that continues from the fixation section and is inserted into the elastic rubber section, and the insertion section has a proximity curved section that is curved in a direction in proximity to the developer bearing member.

In this manner, since the elastic rubber section that makes contact with the developer bearing member in the layer thickness regulating member is formed into the plate shape, the surface precision becomes high compared to an elastic rubber section that is formed into a complex shape such as a convex shape, so that it is possible to form the developer layer uniformly on the developer bearing member. Further, since the insertion section that is inserted into the elastic rubber section in the support section that supports the elastic rubber section has the proximity curved section that is curved in a direction in proximity to the developer bearing member, a distance from the insertion section to a contacting face where the elastic rubber section makes contact with the developer bearing member changes continuously along the proximity curved section. Thereby, the thickness of the elastic rubber section that lies between the insertion section and the developer bearing member changes continuously along the proximity curved section, thus making it possible to change the contacting pressure of the elastic rubber section against the developer bearing member in accordance with the change of the thickness. Therefore, it is possible that a distribution curve of the contacting pressure of the elastic rubber section against the developer bearing member becomes sharp according to the proximity curved section. Accordingly, it is possible to increase the contacting pressure at a narrow area where the elastic rubber section makes contact with the surface of the developer bearing member, thus making it possible to form the thin layer of the developer uniformly on the developer bearing member while preventing occurrence of deterioration of the developer and the like. Thereby, the developing device conveys the developer from the developer bearing member on which the thin layer of the developer is formed uniformly and develops the electrostatic latent image on the image bearing member, so that it is possible to develop the electrostatic latent image with high image quality.

Further, in the invention, it is preferable that the insertion section is provided with a plurality of proximity curved sections in a direction perpendicular to the direction of axis of the developer bearing member.

According to the invention, the insertion section that is inserted into the elastic rubber section in the support section is provided with a plurality of proximity curved sections in a direction perpendicular to the direction of axis of the developer bearing member. Thereby, it is possible to arrange a plurality of parts at which the thickness of the elastic rubber section that lies between the insertion section and the developer bearing member changes continuously according to the proximity curved sections, so that it is possible that a distribution curve of the contacting pressure of the elastic rubber section against the developer bearing member becomes sharp with a plurality of peaks according to the plurality of proximity curved sections. Accordingly, the layer thickness regulating member is capable of having the thin layer of the developer formed more uniformly on the developer bearing member.

Further, in the invention, it is preferable that the insertion section further has a separated curved section that is curved in a direction separated from the developer bearing member, and the proximity curved section and the separated curved section are connected alternately.

According to the invention, the insertion section further has a separated curved section that is curved in a direction separated from the developer bearing member, and the proximity curved section and the separated curved section are connected alternately. Thereby, in the case of die-molding the layer thickness regulating member, at the time of molding in such a way that the elastic rubber constituting the elastic rubber section flows into the proximity curved section and the separated curved section, it is possible to apply the load evenly to each of the curved sections. Accordingly, since the insertion section inserted into the elastic rubber section has the high surface precision, the layer thickness regulating member is capable of having the thin layer of the developer formed more uniformly on the developer bearing member.

Further, the invention provides an image forming apparatus, comprising:
an image bearing member that bears an electrostatic latent image thereon;
a latent image forming section that forms the electrostatic latent image on the image bearing member; and
the mentioned-above developing device that develops the electrostatic latent image formed on the image bearing member, with use of the developer.

According to the invention, an image forming apparatus forms an electrostatic latent image on an image bearing member by a latent image forming section for development by the developing device of the invention capable of forming a thin layer of the developer uniformly on the developer bearing member. Accordingly, the image forming apparatus is capable of forming an image with high image quality, with occurrence of image defects such as unevenness in the image prevented.

### BRIEF DESCRIPTION OF THE DRAWINGS

Other and further objects, features, and advantages of the invention will be more explicit from the following detailed description taken with reference to the drawings wherein:

FIG. 1 is a view showing a configuration of an image forming apparatus according to an embodiment of the invention;

FIG. 2 is a view showing a configuration of a developing device according to an embodiment of the invention;

FIG. 3 is a sectional view showing the configuration of the doctor blade;

FIGS. 4A to 4C are views for explaining distribution of blade linear pressure on a contacting face of an elastic rubber section in contact with the developing roller;

FIGS. 5A and 5B are views showing an adhering state of the developer on the contacting face where the elastic rubber section makes contact with the developing roller; and

FIGS. 6A, 6B, 7A, 7B, 8A and 8B are sectional views showing a configuration of doctor blades.

### DETAILED DESCRIPTION

Now referring to the drawings, preferred embodiments of the invention are described below.

### Image Forming Apparatus

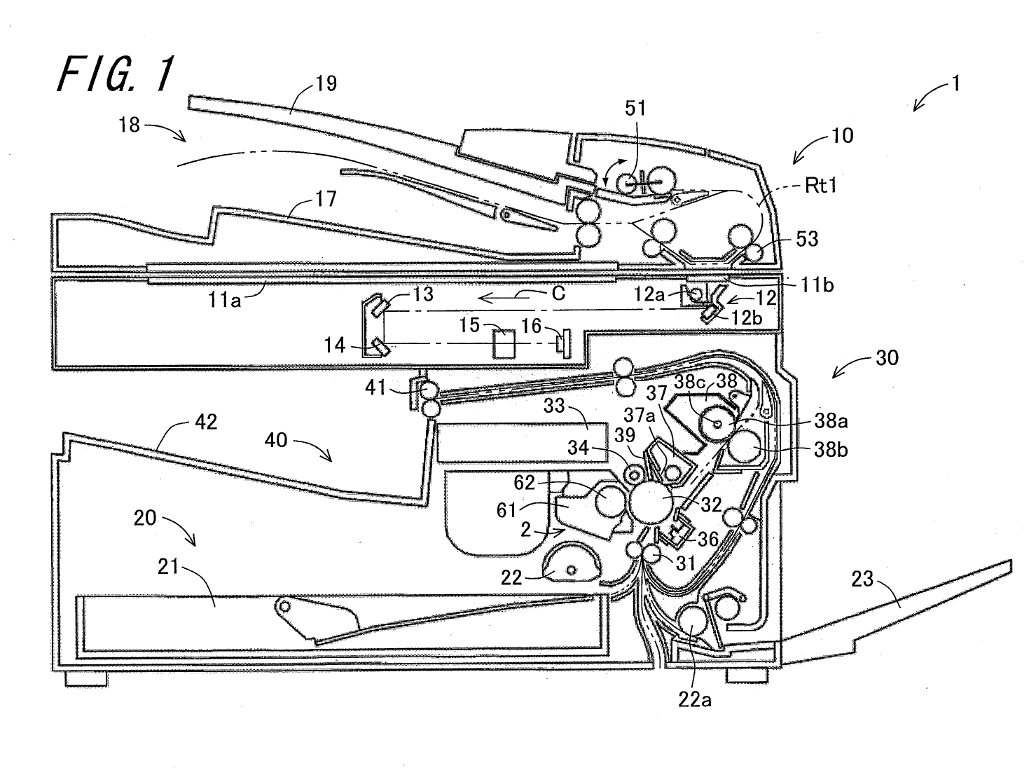

FIG. 1 is a view showing a configuration of an image forming apparatus 1 according to an embodiment of the invention. The image forming apparatus 1 generally comprises a document reading section (hereinafter occasionally referred to as a “scanner section”) 10, an image forming section 30, a paper feeding section 20, and a paper discharge section 40. The document reading section 10 is arranged in an upper part of the paper feeding section 20 in a vertical direction thereof, and the paper discharge section 40 is arranged at a location intermediate between the document reading section 10 and the paper feeding section 20 in the vertical direction.

The image forming section 30 includes a photoreceptor drum 32 which is an image bearing member provided to be rotatable around an axis, a charging unit 34 which is a charging section, a laser scanner unit 33 which is an exposure section, a developing device 2 of the invention which is a developing section, a transfer unit 36 which is a transfer section, a fixing device 38 which is a fixing section, a cleaning unit 37 which is a cleaning section, and a charge removing device 39 which is a charge removing section. The charging unit 34 and the laser scanner unit 33 correspond to a latent image forming section.

The charging unit 34, the laser scanner unit 33, the developing device 2, the transfer unit 36, the cleaning unit 37, and the charge removing device 39 are arranged in this order from an upstream side to a downstream side with respect to the rotational direction of the photoreceptor drum 32 around the photoreceptor drum 32. The photoreceptor drum 32 in this embodiment has a cylindrical column shape. The shape of the photoreceptor drum 32 is not limited to the cylindrical column shape and may be a cylindrical shape, for example.

The developing device 2 is a one component developing device, that uses a non-magnetic one-component developer composed of a toner to develop an electrostatic latent image formed on the photoreceptor drum 32 and forms a toner image. The detailed configuration of the developing device 2 will be described below.

The charging unit 34 constituting the image forming section 30 with the developing device 2 charges an outer circumferential surface of the photoreceptor drum 32. The laser scanner unit 33 exposes the photoreceptor drum 32 that has been charged. The transfer unit 36 transfers the toner image which is a visualized image formed by development, to recording paper serving as a recording medium. The transfer unit 36 is realized by, for example, a corona charger. The fixing device 38 fixes the transferred toner image to the recording paper. More specifically, the fixing device 38 includes a heating roller 38a having a heating source 38c disposed thereinside and a pressure roller 38b which elastically comes into contact with a surface of the heating roller 38a. The cleaning unit 37 includes a cleaning blade 37a and scrapes off and removes, by the cleaning blade 37a, the toner remaining on the outer circumferential surface of the photoreceptor drum 32 after the transferring operation by the transfer unit 36 to clean the outer circumferential surface of the photoreceptor drum 32. The charge removing device 39 removes the charge on the outer circumferential surface of the photoreceptor drum 32 which has been cleaned by the cleaning unit 37.

The document reading section 10 includes a first platen glass 11a, a second platen glass 11b, a copy lamp unit 12 and a document feeding section 18. A document is placed on the first platen glass 11a. A document is fed to the second platen glass 11b from the document feeding section 18. The copy lamp unit 12 reads image information from the document placed on the first platen glass 11a or the document fed to the second platen glass 11b and outputs the image information thus obtained to an image processing section (not shown). The document feeding section 18 feeds the document to the second platen glass 11b.

The copy lamp unit 12 includes a copy lamp 12a, a first mirror 12b, a second mirror 13, a third mirror 14, an optical lens 15 and a CCD (Charge Coupled Device) unit 16. The copy lamp unit 12a is a light source that irradiates light to the document placed on the first platen glass 11a or the document fed to the second platen glass lib. The first mirror 12b deflects a reflected light image from the document in a predetermined direction. The second mirror 13 and the third mirror 14 sequentially deflect the reflected light image from the document, deflected by the first mirror 12b, further in a predetermined direction. The optical lens 15 reduces the size of the reflected light image from the document, deflected by the third mirror 14, to form on the CCD unit 16. The CCD unit 16 is a photoelectric conversion element, and performs photoelectric conversion of the reflected light image from the document, formed by the optical lens 15, to output image information as electric signals to the image processing section.

The document feeding section 18 includes a document tray 19, a paper feeding roller 51, registration rollers 53, and a document discharge tray 17. A document is placed on the document tray 19. The paper feeding roller 51 feeds the document placed on the document tray 19 to a document conveyance path Rt1. The registration rollers 53 temporarily hold the document fed by the paper feeding roller 51 to feed to the second platen glass 11b with appropriate timing. The document whose image information has been read is discharged onto the document discharge tray 17.

The paper feeding section 20 includes a paper feeding cassette 21, a manual tray 23, a first paper feeding roller 22, a second paper feeding roller 22a, and registration rollers 31. A recording paper serving as a recording medium is stored in the paper feeding cassette 21. A recording paper is placed on the manual tray 23. The first paper feeding roller 22 feeds the recording paper stored in the paper feeding cassette 21 to a first conveyance path. The second paper feeding roller 22a feeds the recoding paper placed on the manual tray 23 to a second conveyance path. The registration rollers 31 temporarily hold the recording paper to feed to the image forming section 30 with appropriate timing.

The paper discharge section 40 includes a paper discharge roller 41 and a paper discharge tray 42. The paper discharge roller 41 discharges the recording paper to which the toner image has been fixed by the fixing device 38 of the image forming section 30 onto the paper discharge tray 42. The paper discharge tray 42 stores the recording paper discharged by the paper discharge roller 41.

The image forming apparatus 1 has image formation (hereinafter also referred to as “printing”) modes which include a copy mode (hereinafter also referred to as a “copier mode”), a printer mode, and a facsimile mode. In response to operation inputs from an operation section (not shown) and receipt of a printing job from an external host apparatus such as a personal computer, a corresponding printing mode is selected among the printing modes described above, by a control section (not shown) described below.

In the case of the copier mode among the printing modes described above, an image is formed as follows. A user places a document on the first platen glass 11a of the document reading section 10, supplies recording paper to the paper feeding cassette 21 or the manual tray 23 of the paper feeding section 20, and after inputting the number of printing copies, printing magnification and the like by a condition input key at the operation panel (not shown), actuation of a start key at the operation panel causes a copy operation to start.

Upon actuation of the start key, a main driving motor (not shown) commences operations, and each of driving gears (not shown) rotates. The first paper feeding roller 22 or the second paper feeding roller 22a of the paper feeding section 20 thereafter rotates, and the recoding paper is conveyed (fed) to the first conveyance path or the second conveyance path and reaches a pair of registration rollers 31 to be caught. The registration rollers 31 cause the recording paper to temporarily stop so as to synchronize with timing when a leading edge of the toner image, that is, a part from which image formation will begin, formed on the surface of the photoreceptor drum 32 reaches a location at which the transfer unit 36 is provided and timing when the predetermined image formation area of the recording paper reaches a location at which the transfer unit 36 is provided. In addition, at this time, a leading edge of the recording paper is uniformly pressed against the registration rollers 31 as the location of the leading edge of the recording paper is adjusted.

Moreover, at the document reading section 10, the copy lamp 12a lights, and the copy lamp unit 12 starts to move in the direction indicated by the arrow C which is the direction going from right to left facing a plane of paper of FIG. 1 to begin exposure of the document. Irradiated light from the copy lamp 12a with which the document is irradiated is reflected by the document and becomes reflected light containing document image information. This reflected light from the document enters the CCD unit 16 through the first mirror 12b, the second mirror 13, the third mirror 14, and the optical lens 15. Thereby, the image information of the document is read as an optical signal.

The image information of the document read as an the optical signal is converted to an electrical signal by the CCD unit 16 and outputted to the image processing section. At the image processing section, the input image information is subjected to image processing in accordance with set conditions and the image information subjected to the image processing is sent to the laser scanner unit 33 of the image forming section 30 in the form of printing data.

Furthermore, at the image forming section 30, a part of the outer circumferential surface of the photoreceptor drum 32 is charged to a prescribed electrical potential over the entirety of the photoreceptor drum 32 in the direction of axis thereof by the charging unit 34, and further the photoreceptor drum 32 rotates, so that the whole outer circumferential surface of the photoreceptor drum 32 is charged to a prescribed electrical potential. With rotation of the photoreceptor drum 32, the outer circumferential surface of the photoreceptor drum 32 that has been charged is subjected to the following step sequentially.

At the laser scanner unit 33, laser light emitted from semiconductor laser is deflected, according to printing data inputted from the image processing section, by way of a polygonal mirror having a plurality of reflective faces in the rotational direction (rotating multi-faceted mirror) and various optical systems, which are not shown, to be irradiated onto the photoreceptor drum 32. Thereby, the laser light is scanned by the outer circumferential surface of the photoreceptor drum 32 that has been charged by the charging unit 34 and an electrostatic latent image is formed on the outer circumferential surface of the photoreceptor drum 32.

Then, a toner serving as a developer is supplied to the outer circumferential surface of the photoreceptor drum 32 in rotation by the developing device 2. The toner is adhered to the outer circumferential surface of the photoreceptor drum 32 in accordance with the differences in electrical potential for forming the electrical static latent image. Thereby, the electrostatic latent image is made visible (developed) and a toner image is formed.

In addition, timed by the registration rollers 31 of the paper feeding section 20, the recording paper on which an image is to be formed is fed to a transfer location between the photoreceptor drum 32 and the transfer unit 36. At the transfer location, the toner image formed on the circumferential surface of the photoreceptor drum 32 is transferred to the recording paper by the transfer unit 36.

The recording paper to which the toner image has been transferred is conveyed to the fixing device 38 and applied with heat and pressure while passing between the heating roller 38a and the pressure roller 38b of the fixing device 38. Thereby, the unfixed toner on the surface of the recording paper fuses to be adhered and fixed to the recording paper. The recording paper to which the toner image has been fixed is discharged onto the paper discharge tray 42 by the paper discharge roller 41 of the paper discharge section 40.

In addition, the toner that has not been transferred to the recording paper and remains on the outer circumferential surface of the photoreceptor drum 32 is scraped off and collected by the cleaning blade 37a of the cleaning unit 37. The charge on the outer circumferential surface of the photoreceptor drum 32 from which the remaining toner has been scraped off by the cleaning blade 37a is removed by the charge removing device 39 while moving to a location at which the charging unit 34 is arranged. The charge on the outer circumferential surface of the photoreceptor drum 32 may not be removed by the charge removing device 39, when it is not necessary to remove the charge.

Although image information is read in the state where a document is placed on the first platen glass 11a by a user and remains still, image information may be read while a document is being fed to the second platen glass 11b by the document feeding section 18. In this case, the document is placed on the document tray 19 of the document reading section 10.

In this manner, upon actuation of the start key when it is detected by a sensor (not shown) that the document is placed on the document tray 19 of the document reading section 10, the paper feeding roller 51 of the document feeding section 18 rotates and the document placed on the document tray 19 is fed to the document conveyance path Rt1. The document fed to the document conveyance path Rt1 is caught by the registration rollers 53 provided in the document conveyance path Rt1, and after positioning a leading edge of the document, conveyed to a location at which the second platen glass 11b is provided, serving as a document reading location, at predetermined timing. The copy lamp unit 12 exposes the document being conveyed while stopping at a predetermined stopping location serving as a document reading location. The reflected light from the document obtained by the exposure is read as a document image as described above. The document whose image information has been read in this manner is discharged onto the document discharge tray 17.

In the case of the printer mode described above, the document reading section 10 is not actuated and an image is formed according to image information inputted from an external host apparatus such as a personal computer. Moreover, in the case of the facsimile mode, an image is formed according to image information inputted through a communication line.

### Developing Device

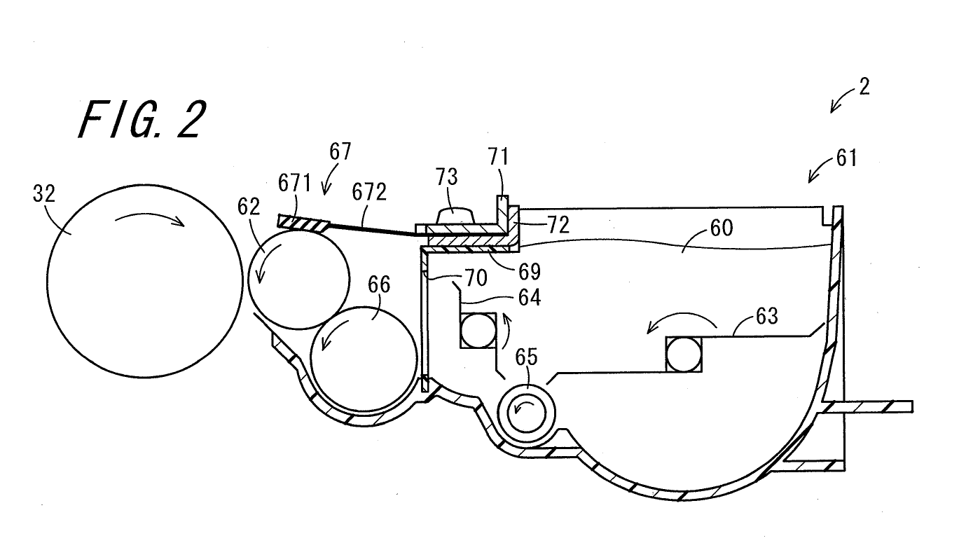

FIG. 2 is a view showing a configuration of a developing device 2 according to an embodiment of the invention. The developing device 2 includes a developer tank 61 which stores the developer 60, a developing roller 62 which is a developer bearing member, first, second and third stirring conveyance members 63, 64 and 65 which are provided inside the developer tank 60 and stir and convey the developer 60, a toner supply roller 66, and a doctor blade 67 which is a layer thickness regulating member.

The developer tank 61 is a container member composed of, for example, a hard synthetic resin or the like and whose external appearance has a substantially cuboid shape. In this embodiment, the developer 60 stored in the developer tank 61 is a non-magnetic one-component developer composed of a toner. Note that, in this embodiment, as the non-magnetic one-component developer, a toner having a volume average particle size of 7 pm whose main component is a polyester resin and produced by a pulverization method is used.

The developing roller 62, provided to be rotatable in the developer tank 61, bears the developer 60 stored in the developer tank 61 to convey to the photoreceptor drum 32. The developing roller 62 is arranged facing the photoreceptor drum 32 so that an axis thereof becomes parallel to an axis of rotation of the photoreceptor drum 32, and supported by a frame section of a main body of the developer tank 61. A rotational direction of the developing roller 62 is opposite to that of the photoreceptor drum 32. In this embodiment, the developing roller 62 is composed of aluminum, having a diameter of 16 mm, and subjected to sandblast treatment so that an arithmetic average roughness Ra is 0.3 to 0.5 μm. Further, the developing roller 62 is driven to rotate around the axis at a peripheral speed of 145 mm/second.

The first, second and third stirring conveyance members 63, 64 and 65 are provided to be rotatable in the developer tank 61 and each of rotational directions is the same as that of the developing roller 62. The first stirring conveyance member 63 and the second stirring conveyance member 64 serve to stir and convey the developer 60 mainly in the rotational direction inside the developer tank 61. The first stirring conveyance member 63 and the second stirring conveyance member 64 comprise a rotation shaft section and a plurality of vane pieces protruding outward from the rotation shaft section in a radial direction thereof, and the vane piece is formed into a thin-plate shape using, for example, a resin such as PET. Further, the third stirring conveyance member 65 is a screw-like rotating member formed by using a hard synthetic resin, and serves to stir and convey the developer 60 mainly in the direction of axis.

The toner supply roller 66 is provided to be rotatable in the developer tank 61, and a rotational direction thereof is the same as that of the developing roller 62. The toner supply roller 66 is one in which a cylindrical porous elastic member such as foamed urethane is provided around a metal core, and frictions the developing roller 62 while adsorbing the developer 60 into pores on the surface thereof, thus supplying the developer 60 to the developing roller 62 as well as cleaning the residual developer 60 remained on the developing roller 62 after development.

Further, in the developer tank 61, an intermediate wall member 69 is provided between the second stirring conveyance member 64 and the toner supply roller 66. The intermediate wall member 69 is a flat plate-like member composed of, for example, a synthetic resin or the like, and is provided to extend in a longitudinal direction of the developer tank 61 (direction of axis of the developing roller 62) so as to rise up from a bottom part of the developer tank 61. Then, the intermediate wall member 69 has an opening section 70 at the center part thereof. Such intermediate wall member 69 forms a flow of the developer 60 inside the developer tank 61 flowing from the second stirring conveyance member 64 toward the toner supply roller 66.

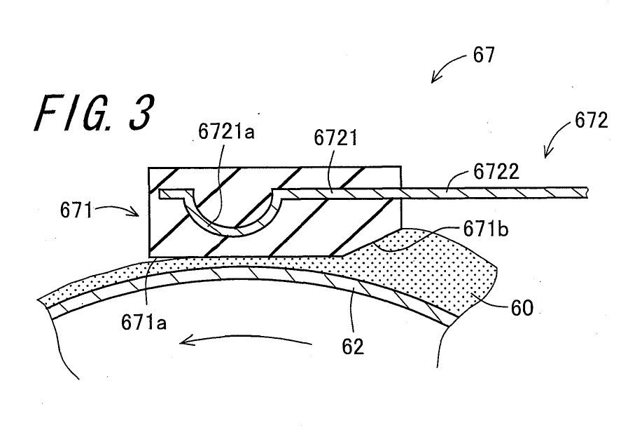

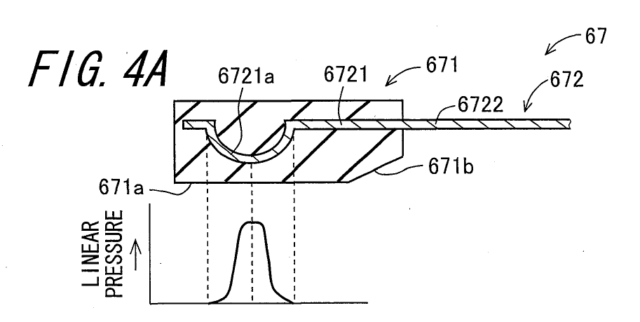

A doctor blade 67 is provided to come into pressure-contact with the developing roller 62 to regulate the layer thickness of the developer 60 borne by the developing roller 62 which is driven to rotate. In this embodiment, a pressing force for bringing the doctor blade 67 in pressure-contact with the developing roller 62 is set to 15 gf/cm (14.7 N/m). Description will be given in detail for the doctor blade 67 with reference to FIG. 3 and FIGS. 4A to 4C. FIG. 3 is a sectional view showing the configuration of the doctor blade 67. Note that, FIG. 3 is a sectional view from the direction of axis of the developing roller 62. FIGS. 4A to 4C are views for explaining distribution of blade linear pressure on a contacting face 671a of an elastic rubber section 671 in contact with the developing roller 62.

The doctor blade 67 includes the elastic rubber section 671 and a support section 672. The elastic rubber section 671 is formed into a plate shape and provided so as to make surface contact with the surface of the developing roller 62 over between both ends in the direction of axis of the developing roller 62. In this manner, since the elastic rubber section 671 that makes contact with the developing roller 62 in the doctor blade 67 is formed into a plate shape, the surface precision becomes high compared to an elastic rubber section that is formed into a complex shape such as a convex shape, so that it is possible to form the developer layer uniformly on the developing roller 62.

As a material to constitute the elastic rubber section 671, urethane rubber, silicone runner and the like are included. Moreover, it is preferable that hardness of the elastic rubber section 671 is set to JIS A harness of 65° to 85°, and the hardness is set to 75° to 80° in this embodiment. Furthermore, in this embodiment, the elastic rubber section 671 is set such that the thickness is 1 mm, a distance from the contacting face 671a in contact with the surface of the developing roller 62 to a fixation section 6722 of the support section 672 is 0.8 mm, and a length corresponding to a direction perpendicular to the direction of axis of the developing roller 62 is 8 mm. Moreover, the elastic rubber section 671 has a notch section 671b formed on an end of the upstream side with respect to the rotational direction of the developing roller 62. The notch section 671b makes entering of the developer 60 borne on the surface of the developing roller 62 smoothly in rotating to be conveyed to the contacting face 671a. A shape and a dimension of the notch section 671b may be set as appropriate in consideration of the properties of substance of the developer 60 and the size of the developing roller 62.

The support section 672 is formed into a plate shape having elasticity, for supporting the elastic rubber section 671. A material constituting the support section 672 is not particularly limited as far as satisfying such conditions as having elasticity and being resistant to heating in die-molding the elastic rubber section 671, and examples thereof include a phosphor-bronze plate, a stainless steel plate, and a beryllium copper plate. In this embodiment, the support section 672 is composed of a phosphor-bronze plate whose thickness is 0.12 mm and a length of the fixation section 6722 is set to 25 mm.

The support section 672 includes the fixation section 6722 and an insertion section 6721. The fixation section 6722 is formed into a plate shape parallel to the axis of the developing roller 62, and has one end held between holding members 71 and 72 to be fixed to the developer tank 61 by a screw 73.

The insertion section 6721 in the support section 672 is a part that continues from the other end of the fixation section 6722 and is inserted into the elastic rubber section 671. In addition, the insertion section 6721 has a proximity curved section 6721a that is curved in a direction in proximity to the developing roller 62. In this embodiment, the sectional shape of the proximity curved section 6721a is a sectional configuration of a semi-circular shape curved in a direction in proximity to the developing roller 62. More specifically, the proximity curved section 6721a is set so that the radius of the semi-circular shape is 0.5 mm.

In this manner, the insertion section 6721 in the support section 672 has the proximity curved section 6721a curved in a direction in proximity to the developing roller 62, thus a distance from the insertion section 6721 to the contacting face 671a where the elastic rubber section 671 makes contact with the developing roller 62 changes continuously along the proximity curved section 6721a. Thereby the thickness of the elastic rubber section 671 that lies between the insertion section 672 and the developing roller 62 changes continuously along the proximity curved section 6721a.

In this embodiment, a distance from the contacting face 671a of the elastic rubber section 671 to the fixation section 6722 of the support section 672 is set to 0.8 mm with respect to the elastic rubber section 671 having the thickness of 1 mm and the proximity curved section 6721a is formed into a semi-circular shape whose radius is 0.5 mm, and thus allowing the thickness of the elastic rubber section 671 that lies between a part, which is most approximate to the developing roller 62, of the proximity curved section 6721a and the developing roller 62 to be 0.3 mm, and the thickness in a part therearound changes continuously within a range of 0.3 to 0.8 mm.

In this manner, in the doctor blade 67 of this embodiment, the thickness of the elastic rubber section 671 that lies between the insertion section 6721 and the developing roller 62 changes continuously along the proximity curved section 6721a, thus making it possible to change the contacting pressure of the elastic rubber section 671 against the developing roller 62 in accordance with the change of the thickness.

Thereby, it is possible that a distribution curve of the contacting pressure of the elastic rubber section 671 against the developing roller 62 becomes sharp according to the proximity curved section 6721a, as shown in FIG. 4A. Accordingly, it is possible to increase the contacting pressure of a narrow area where the elastic rubber section 671 makes contact with the surface of the developer roller 62, so that it is possible to form the thin layer of the developer 60 uniformly on the surface of the developing roller 62 while preventing occurrence of deterioration of the developer 60 or the like. The developing device 2 thereby conveys the developer 60 from the developing roller 62 on which the thin layer of the developer 60 is formed uniformly in order to develop an electrostatic latent image on the photoreceptor drum 32, thus making it possible to develop the electrostatic latent image with high image quality. Therefore, the image forming apparatus 1 is capable of forming a high-quality image with occurrence of image defects such as unevenness in an image or background fogging prevented.

Note that, in the developing device 2 of this embodiment, the layer thickness of the developer 60 borne on the surface of the developing roller 62 is regulated using the doctor blade 67, thus making it possible to form a developer layer of a uniform thin layer whose adhering amount of the developer (toner) 60 is 0.5 to 0.7 mg/cm² on the surface of the developing roller 62, so that a charging amount is also able to be adjusted to be within a range of −10 to −15 μC/g.

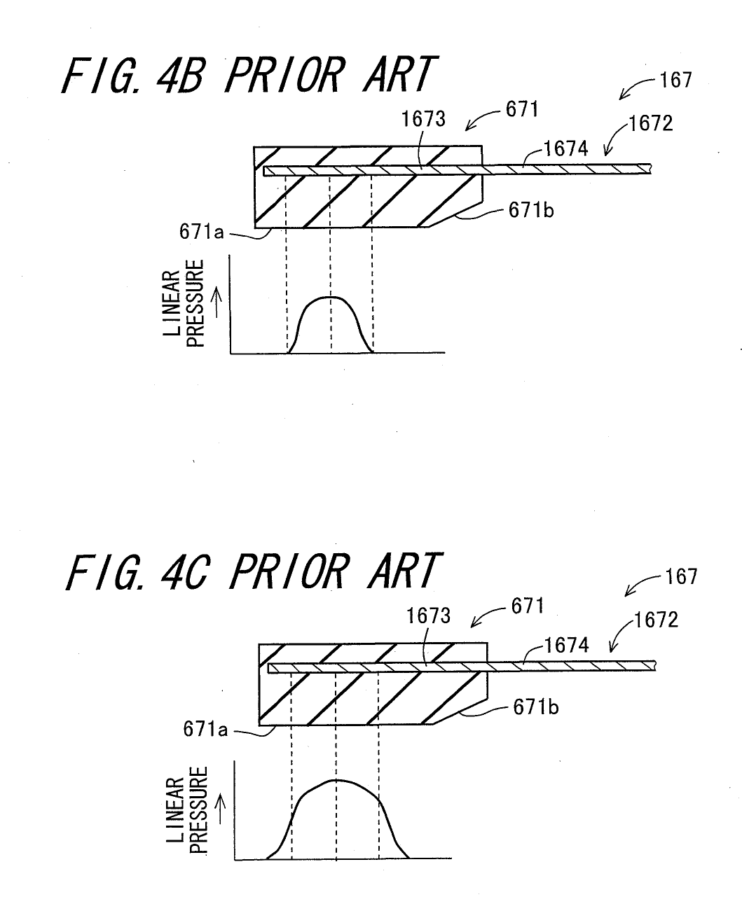

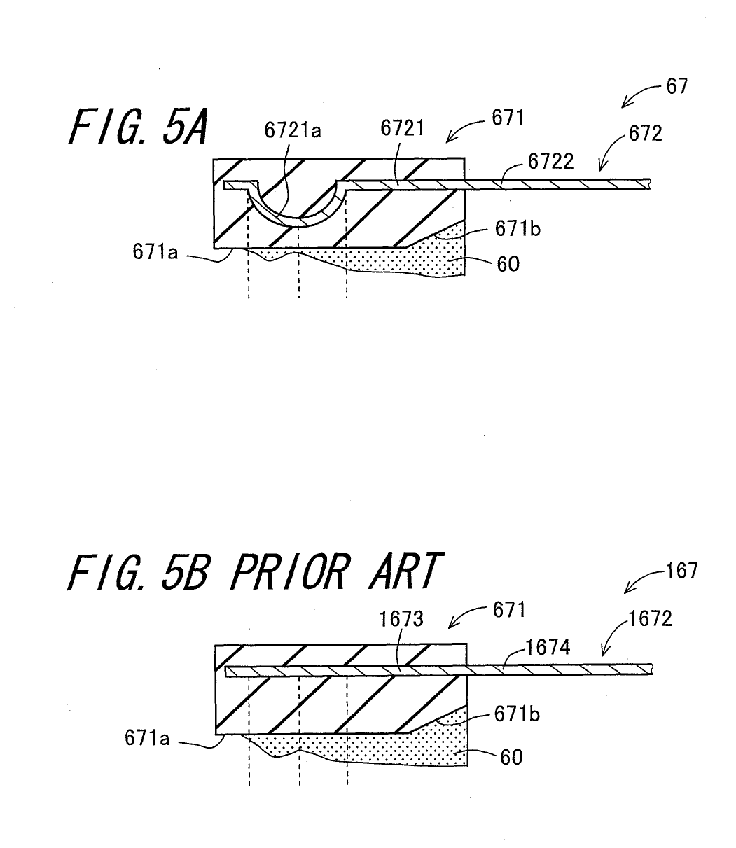

Further, it is possible to confirm that the uniform thin layer of the developer 60 is able to be formed on the surface of the developing roller 62 by using the doctor blade 67 of this embodiment by observing an adhering state of the developer 60 on the contacting face 671a where the elastic rubber section 671 makes contact with the developing roller 62. FIGS. 5A and 5B are views showing an adhering state of the developer 60 on the contacting face 671a where the elastic rubber section 671 makes contact with the developing roller 62.

As shown in FIG. 5A, in the doctor blade 67 of this embodiment, the developer 60 is adhered uniformly on the contacting face 671a of the elastic rubber section 671 in a state where the thickness in a place of the proximity curved section 6721a corresponding to a part which is the most approximate to the developing roller 62 is the smallest, and an adhering amount of the developer 60 thereto is small. As is clear from this, it is found that the contacting pressure of the elastic rubber section 671 against the developing roller 62 is increased corresponding to the part most approximate to the developing roller 62 in the proximity curved section 6721a, thereby enabling to form the thin layer of the developer 60 uniformly on the surface of the developing roller 62.

Meanwhile, description will be given for a distribution of the contacting pressure in a developing device of a conventional technology with reference to FIGS. 4B, 4C and 5B. In a doctor blade 167 provided in a developing device of a conventional technology, a proximity curved section is not included in an insertion section 1673 inserted into the elastic rubber section 671. Therefore, in the doctor blade 167 of the conventional technology, the distribution curve of the contacting pressure of the elastic rubber section 671 against the developing roller 62 becomes broad as shown in FIG. 4B. Therefore, it is difficult to reduce the thickness of the developer layer formed on the surface of the developing roller 62 in the doctor blade 167 of the conventional technology. This is clear from the result shown in FIG. 5B obtained by observing an adhering state of the developer 60 on the contacting face 671a of the elastic rubber section 671.

Note that, in the developing device of the conventional technology provided with the doctor blade 167, the developer layer formed on the surface of the developing roller 62 has a thick film whose adhering amount of the developer 60 is 1.0 to 1.5 mg/cm², and the charging amount is a low value such as −5 μC/g.

Additionally, in the case where the doctor blade 167 of the conventional technology is used, the contacting pressure of the elastic rubber section 671 against the developing roller 62 is increased so that the thickness of the developer layer to be formed on the surface of the developing roller 62 is able to be reduced, however, in this case, as shown in FIG. 4C, the contact area of the elastic rubber section 671 with the developing roller 62 becomes large, and moreover the pressure becomes high over the whole area. Thus, excess stress is placed on the developer layer formed on the surface of the developer layer 62, and the developer 60 constituting the developer layer is deteriorated, resulting in a problem of causing image defects. In addition, when the pressure is high over the whole area of the surface of the developing roller 62, deformation of the developer tank 61 of the developing device 2 supporting the developing roller 62 is easily caused, and there are concerns that cost will be high in order to take a measure to improve the strength for avoiding the occurrence of deformation and the like.

In the developing device 2 of this embodiment, as described above, it is possible that the distribution of the contacting pressure of the elastic rubber section 671 against the developing roller 62 becomes sharp according to the proximity curved section 6721a. Therefore it is possible to increase the contacting pressure at a narrow area where the elastic rubber section 671 makes contact with the surface of the developing roller 62, thus making it possible to form a thin layer of the developer 60 uniformly on the surface of the developing roller 62 without increasing the contacting pressure over the whole area of the elastic rubber section 671. Accordingly, a thin layer of the developer 60 is able to be formed uniformly on the surface of the developing roller 62 while preventing deformation of the developer tank 61 and the like as well as preventing occurrence of deterioration of the developer 60 and the like.

Note that, the doctor blade 67 in the developing device 2 of this embodiment is able to be produced by injecting a rubber material in a fused state constituting the elastic rubber section 671 into a mold in which the support section 672 provided with the proximity curved section 6721a is set and die-molding under heat and pressure applied.

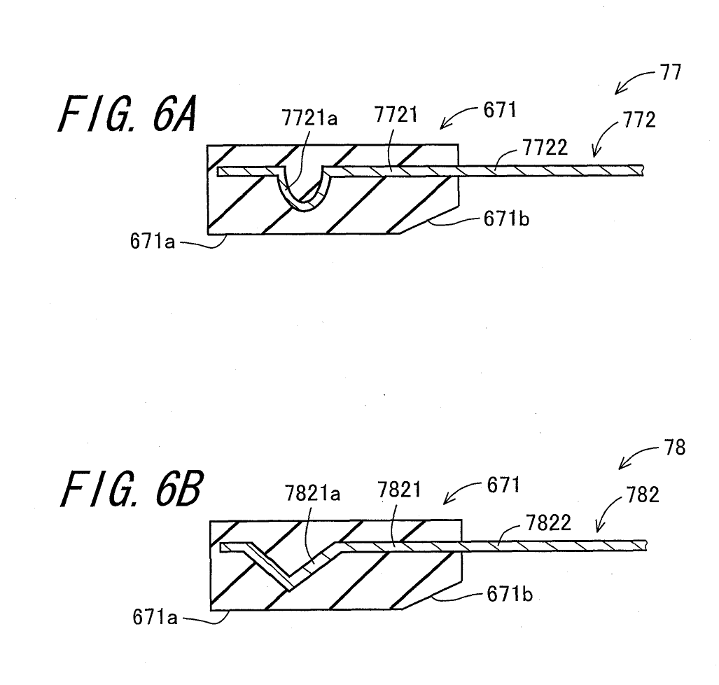

In the developing device 2 of this embodiment, the doctor blade that regulates the layer thickness of the developer 60 borne on the surface of the developing roller 62 is not limited to the doctor blade 67 shown in FIG. 3. With reference to FIGS. 6A, 6B, 7A, 7B, 8A and 8B, another embodiment of the doctor blade provided in the developing device 2 of this embodiment will be described.

FIG. 6A is a sectional view showing a configuration of a doctor blade 77. FIG. 6B is a sectional view showing a configuration of a doctor blade 78. Note that, FIGS. 6A and 6B are sectional views from the direction of axis of the developing roller 62.

The doctor blade 77 shown in FIG. 6A has a configuration similar to that of the doctor blade 67 described above, and is similar to the doctor blade 67 except for a shape of an insertion section 7721 that is inserted into the elastic rubber section 671 in a support section 772. The insertion section 7721 in the support section 772 of the doctor blade 77 is a part that continues from the other end of a fixation section 7722 and is inserted into the elastic rubber section 671. In addition, the insertion section 7721 has a proximity curved section 7721a that is curved in a direction in proximity to the developing roller 62. In this embodiment, the sectional shape of the proximity curved section 7721a from the direction of axis of the developing roller 62 is a semiellipse shape curved in a direction in proximity to the developing roller 62. More specifically, the sectional shape of the proximity curved section 7721a is the semiellipse shape in which a short axis is parallel to the fixation section 7722. Thereby, it is possible that a distribution curve of the contacting pressure of the elastic rubber section 671 against the developing roller 62 becomes sharper according to the proximity curved section 7721a. Thus, it is possible to increase the contacting pressure at a narrow area where the elastic rubber section 671 makes contact with the surface of the developing roller 62, thus making it possible to form the thin layer of the developer 60 uniformly on the surface of the developing roller 62 while preventing occurrence of deterioration of the developer 60 and the like.

The doctor blade 78 shown in FIG. 6B has a configuration similar to that of the doctor blade 67 described above, and is similar to the doctor blade 67 except for a shape of an insertion section 7821 that is inserted into the elastic rubber section 671 in a support section 782. The insertion section 7821 in the support section 782 of the doctor blade 78 is a part that continues from the other end of a fixation section 7822 and is inserted into the elastic rubber section 671. In addition, the insertion section 7821 has a proximity curved section 7821a that is curved in a direction in proximity to the developing roller 62. In this embodiment, the sectional shape of the proximity curved section 7821a from the direction of axis of the developing roller 62 is an inverted triangle shape curved in a direction in proximity to the developing roller 62. Thereby, it is possible that a distribution curve of the contacting pressure of the elastic rubber section 671 against the developing roller 62 becomes sharper according to the proximity curved section 7821a. Thus, it is possible to increase the contacting pressure at a narrow area where the elastic rubber section 671 makes contact with the surface of the developing roller 62, thus making it possible to form the thin layer of the developer 60 uniformly on the surface of the developing roller 62 while preventing occurrence of deterioration of the developer 60 and the like.

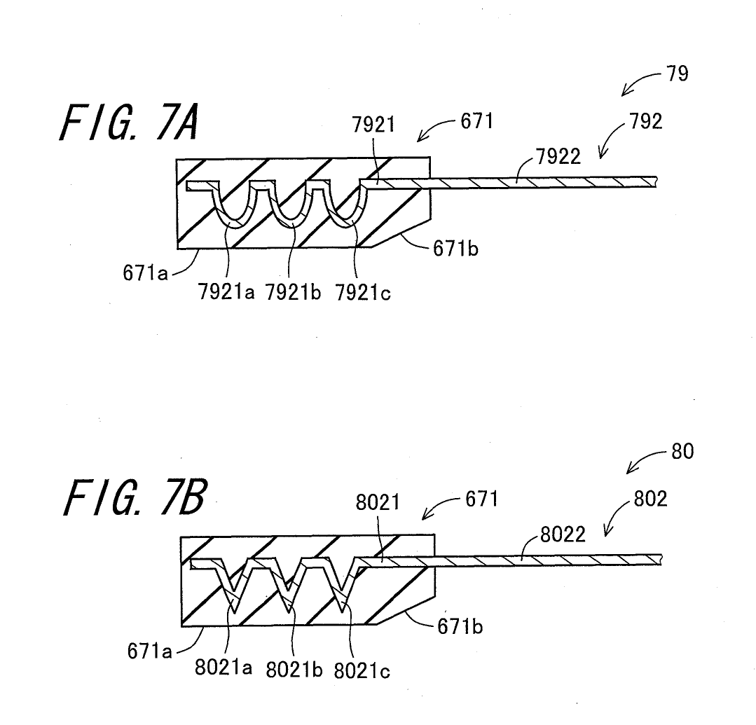

FIG. 7A is a sectional view showing a configuration of a doctor blade 79. FIG. 7B is a sectional view showing a configuration of a doctor blade 80. Note that, FIGS. 7A and 7B are sectional views from the direction of axis of the developing roller 62.

The doctor blade 79 shown in FIG. 7A has a configuration similar to that of the doctor blade 67 described above, and is similar to the doctor blade 67 except for a shape of an insertion section 7921 that is inserted into the elastic rubber section 671 in a support section 792. The insertion section 7921 in the support section 792 of the doctor blade 79 is a part that continues from the other end of a fixation section 7922 and is inserted into the elastic rubber section 671. Moreover, in the insertion section 7921, a plurality of proximity curved sections 7921a, 7921b, and 7921c that are curved in a direction in proximity to the developing roller 62 are arranged side by side in a direction perpendicular to the direction of axis of the developing roller 62 and the direction in which the insertion section 7921 extends from the fixation section 7922. The sectional shape of each of the proximity curved sections 7921a, 7921b, and 7921c from the direction of axis of the developing roller 62 is a semiellipse shape curved in a direction in proximity to the developing roller 62. More specifically, the sectional shape of each of the proximity curved sections 7921a, 7921b, and 7921c is the semiellipse shape in which a short axis is parallel to the fixation section 7922. Moreover, a distance between each of the proximity curved sections 7921a, 7921b, and 7921c is set to 1 mm in this embodiment.

In this manner, when the plurality of proximity curved sections 7921a, 7921b, and 7921c are provided in the insertion section 7921, it is possible to arrange a plurality of parts at which the thickness of the elastic rubber section 671 that lies between the insertion section 7921 and the developing roller 62 changes continuously according to the proximity curved sections, so that it is possible that the distribution curve of the contacting pressure of the elastic rubber section 671 against the developing roller 62 becomes sharp with a plurality of peaks according to the plurality of proximity curved sections 7921a, 7921b, and 7921c. Accordingly, the doctor blade 79 is capable of having the thin layer of the developer 60 formed more uniformly on the surface of the developing roller 62.

The doctor blade 80 shown in FIG. 7B has a configuration similar to that of the doctor blade 67 described above, and is similar to the doctor blade 67 except for a shape of an insertion section 8021 that is inserted into the elastic rubber section 671 in a support section 802. The insertion section 8021 in the support section 802 of the doctor blade 80 is a part that continues from the other end of a fixation section 8022 and is inserted into the elastic rubber section 671. Moreover, in the insertion section 8021, a plurality of proximity curved sections 8021a, 8021b, and 8021c that are curved in a direction in proximity to the developing roller 62 are arranged side by side in a direction perpendicular to the direction of axis of the developing roller 62 and the direction in which the insertion section 8021 extends from the fixation section 8022. The sectional shape of each of the proximity curved sections 8021a, 8021b, and 8021c from the direction of axis of the developing roller 62 is an inverted triangle shape curved in a direction in proximity to the developing roller 62. Moreover, a distance between each of the proximity curved sections 8021a, 8021b, and 8021c is set to 1 mm in this embodiment.

In this manner, when the plurality of proximity curved sections 8021a, 8021b, and 8021c are provided in the insertion section 8021, it is possible to arrange a plurality of parts at which the thickness of the elastic rubber section 671 that lies between the insertion section 8021 and the developing roller 62 changes continuously according to the proximity curved sections, so that it is possible that the distribution curve of the contacting pressure of the elastic rubber section 671 against the developing roller 62 becomes sharp with a plurality of peaks according to the plurality of proximity curved sections 8021a, 8021b, and 8021c. Accordingly, the doctor blade 80 is capable of having the thin layer of the developer 60 formed more uniformly on the surface of the developing roller 62.

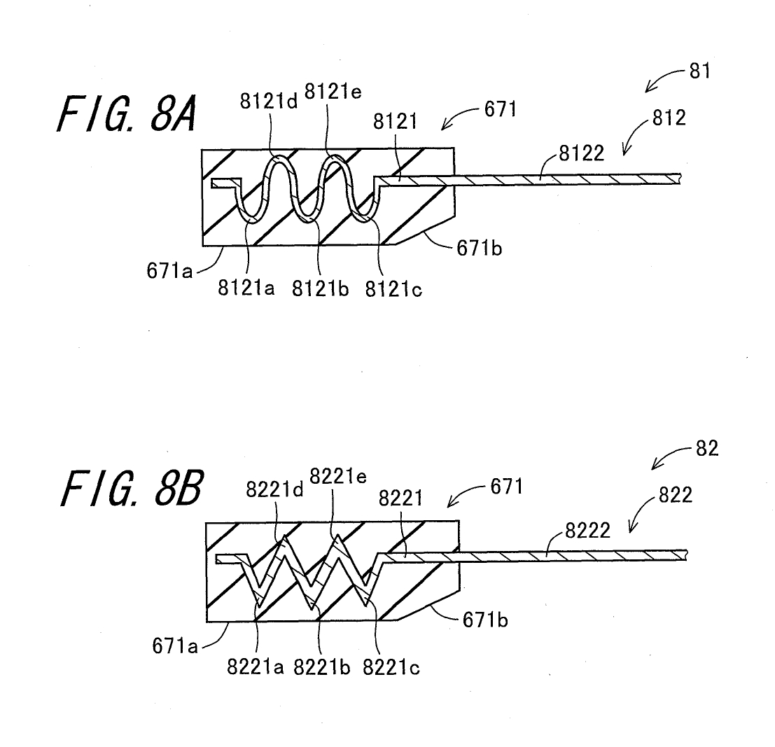

FIG. 8A is a sectional view showing a configuration of a doctor blade 81. FIG. 8B is a sectional view showing a configuration of a doctor blade 82. Note that, FIGS. 8A and 8B are sectional views from the direction of axis of the developing roller 62.

The doctor blade 81 shown in FIG. 8A has a configuration similar to that of the doctor blade 67 described above, and is similar to the doctor blade 67 except for a shape of an insertion section 8121 that is inserted into the elastic rubber section 671 in a support section 812. The insertion section 8121 in the support section 812 of the doctor blade 81 is a part that continues from the other end of a fixation section 8122 and is inserted into the elastic rubber section 671. Moreover, in the insertion section 8121, a plurality of proximity curved sections 8121a, 8121b, and 8121c that are curved in a direction in proximity to the developing roller 62 and a plurality of separated curved sections 8121d and 8121e that are curved in a direction separated from the developing roller 62 are alternately connected side by side in a direction perpendicular to the direction of axis of the developing roller 62 and the direction in which the insertion section 8121 extends from the fixation section 8122. The sectional shape of each of the proximity curved sections 8121a, 8121b, and 8121c and the separated curved sections 8121d and 8121e from the direction of axis of the developing roller 62 is a semiellipse shape in which a short axis is parallel to the fixation section 8122.

Thereby, in the case of die-molding the doctor blade 81, at the time of molding in such a way that the elastic rubber constituting the elastic rubber section 671 flows into the proximity curved sections 8121a, 8121b, and 8121c and the separated curved sections 8121d and 8121e, it is possible to apply the load evenly to each of the curved sections. Accordingly, since the insertion section 8121 inserted into the elastic rubber section 671 has the high surface precision, the doctor blade 81 is capable of having the thin layer of the developer 60 formed more uniformly on the surface of the developing roller 62.

The doctor blade 82 shown in FIG. 8B has a configuration similar to that of the doctor blade 67 described above, and is similar to the doctor blade 67 except for a shape of an insertion section 8221 that is inserted into the elastic rubber section 671 in a support section 822. The insertion section 8221 in the support section 822 of the doctor blade 82 is a part that continues from the other end of a fixation section 8222 and is inserted into the elastic rubber section 671. Moreover, in the insertion section 8221, a plurality of proximity curved sections 8221a, 8221b, and 8221c that are curved in a direction in proximity to the developing roller 62 and a plurality of separated curved sections 8221d and 8221e that are curved in a direction separated from the developing roller 62 are alternately connected side by side in a direction perpendicular to the direction of axis of the developing roller 62 and the direction in which the insertion section 8221 extends from the fixation section 8222. The sectional shape of each of the proximity curved sections 8221a, 8221b, and 8221c and the separated curved sections 8221d and 8221e from the direction of axis of the developing roller 62 is an inverted triangle shape.

Thereby, in the case of die-molding the doctor blade 82, at the time of molding in such a way that the elastic rubber constituting the elastic rubber section 671 flows into the proximity curved sections 8221a, 8221b, and 8221c and the separated curved sections 8221d and 8221e, it is possible to apply the load evenly to each of the curved sections. Accordingly, since the insertion section 8221 inserted into the elastic rubber section 671 has the high surface precision, the doctor blade 82 is capable of having the thin layer of the developer 60 formed more uniformly on the surface of the developing roller 62.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A developing device for developing an electrostatic latent image borne on an image bearing member provided to be rotatable, with use of a developer, comprising:
a developer tank that stores the developer;
a developer bearing member that is provided to be rotatable in the developer tank and is arranged facing the image bearing member so that an axis thereof is parallel to an axis of the image bearing member, and bears and conveys the developer stored in the developer tank to the image bearing member; and
a layer thickness regulating member that is provided to come into pressure-contact with the developer bearing member, and regulates layer thickness of the developer borne on the developer bearing member,
the layer thickness regulating member having
an elastic rubber section that is formed into a plate shape and is provided so as to make surface contact with the developer bearing member over between both ends thereof in a direction of axis of the developer bearing member, and
a support section that is elastic, and supports the elastic rubber section, and
the support section having
a fixation section that is formed into a plate shape in parallel to the axis of the developer bearing member and has one end fixed to the developer tank, and
an insertion section that continues from the other end of the fixation section and is inserted into the elastic rubber section, the insertion section having a proximity curved section that is curved in a direction in proximity to the developer bearing member.

2. The developing device of claim 1, wherein the insertion section is provided with a plurality of proximity curved sections in a direction perpendicular to the direction of axis of the developer bearing member.

3. The developing device of claim 1, wherein the insertion section further has a separated curved section that is curved in a direction separated from the developer bearing member, and the proximity curved section and the separated curved section are connected alternately.

4. An image forming apparatus, comprising:
an image bearing member that bears an electrostatic latent image thereon;
a latent image forming section that forms the electrostatic latent image on the image bearing member; and
the developing device of claim 1 that develops the electrostatic latent image formed on the image bearing member, with use of the developer.
